(19) United States
(12) Patent Application Publication
(10) Pub. No.: US 2026/0078207 A1
(43) Pub. Date: Mar. 19, 2026

(54) PROCESS FOR PREPARING ETHYLENE COPOLYMER

(71) Applicant: SABIC GLOBAL TECHNOLOGIES B.V., Bergen op Zoom (NL)

(72) Inventors: Francisco Perez Valencia, Geleen (NL); Job Daniel Guzman Carrazco, Houston, TX (US); Sarah Lucy Jones, Stockton-on-Tees, North Yorkshire (GB)

(21) Appl. No.: 19/109,698

(22) PCT Filed: Sep. 5, 2023
(86) PCT No.: PCT/EP2023/074347

§ 371 Date: Mar. 7, 2025

(30) Foreign Application Priority Data
Sep. 14, 2022 (EP) 22195527.1

(51) Int. Cl. C08F 210/16

(52) U.S. Cl. CPC C08F 210/16

(57) ABSTRACT

A process for the preparation of a multimodal ethylene copolymer in a reactor cascade, the process comprising:
a) feeding ethylene, hydrogen and catalyst components and a first diluent to a first polymerization reactor to prepare a first suspension of solid particles of an ethylene homopolymer in a first suspension medium,
b) feeding at least part of the first suspension to a first solid-liquid separator to obtain a first diluent stream rich in the first diluent and a first particles stream-rich in the solid particles,
c) feeding the first particles stream to a flash section comprising a first flash vessel and an optional second flash vessel to obtain a vapor stream rich in hydrogen and a hydrogen-depleted stream, and
d) feeding the hydrogen-depleted stream, ethylene and a comonomer and a second diluent to a second polymerization reactor to prepare a second suspension of solid particles of the multimodal ethylene copolymer in a second suspension medium.

### CROSS REFERENCE TO RELATED APPLICATIONS

This application is a National Stage application of PCT/EP2023/074347, filed Sep. 5, 2023, which claims the benefit of European Application No. 22195527.1, filed Sep. 14, 2022, both of which are incorporated by reference in their entirety herein.

### BACKGROUND

The present invention relates to a process for the preparation of an ethylene copolymer.

The production of polymer powder by polymerization reactions of monomers in the presence of catalysts is well-known. Commercial use of fluidized bed reactors and suspension polymerization reactors are known.

In a suspension polymerization reactor, the polymerization is conducted in a stirred tank or a continuous loop reactor in which a suspension of polymer particles in a suspension medium comprising a hydrocarbon diluent is circulated. During the course of polymerization, fresh polymer is generated by the catalytic polymerization of monomer, and polymer product is removed from the reactor by removing a portion of the suspension.

Cost efficiency and energy efficiency are important factors for a polymerization process. Cost and energy efficiency is improved by recycling of the components used in the polymerization process. In a suspension polymerization process for preparing ethylene copolymers, various components used for the polymerization are typically recycled, such as ethylene, the comonomer, the diluent and hydrogen.

WO2019243384A1 discloses a process for preparing a multimodal ethylene copolymer in suspension in a reactor cascade. The process comprises
separating the suspension formed in the reactor cascade into multimodal ethylene copolymer particles and recovered suspension medium,
purifying a part of the recovered suspension medium in a purification section for producing purified components of the recovered suspension medium, and
recycling at least some or a part of the purified components of the recovered suspension medium to the first polymerization reactor of the reactor cascade, wherein the purified components of the recovered suspension medium recycled to the first polymerization reactor, which comprise the diluent, undergo a catalytic hydrogenation before being introduced into the first polymerization reactor.

WO2019243384A1 further discloses an embodiment in which the suspension of polyethylene particles withdrawn from the first polymerization reactor of the reactor cascade is fed into a separator, in which a part of the suspension medium is separated from the suspension and recycled to the first polymerization reactor of the reactor cascade and a concentrated suspension of polyethylene particles is transferred into the next polymerization reactor of the reactor cascade.

There is a need in the art for a low energy consumption process for the preparation of a multimodal ethylene copolymer.

### SUMMARY

It is an object of the present invention to provide a low energy consumption process for the preparation of a multimodal ethylene copolymer.

Accordingly, the present invention provides a process for the preparation of a multimodal ethylene copolymer in a reactor cascade comprising a first polymerization reactor and a second polymerization reactor connected in series, the process comprising:
a) feeding ethylene, hydrogen and catalyst components and a first diluent to the first polymerization reactor to prepare a first suspension of solid particles of an ethylene homopolymer in a first suspension medium,
b) feeding at least part of the first suspension to a first solid-liquid separator to obtain a first diluent stream rich in the first diluent and a first particles stream rich in the solid particles, wherein at least part of the first diluent stream is recycled back to the first polymerization reactor,
c) feeding the first particles stream to a flash section comprising a first flash vessel and an optional second flash vessel to obtain a vapor stream rich in hydrogen and a hydrogen-depleted stream, wherein at least part of the vapor stream is recycled back to the first polymerization reactor and
d) feeding the hydrogen-depleted stream, ethylene and a comonomer and a second diluent to the second polymerization reactor to prepare a second suspension of solid particles of the multimodal ethylene copolymer in a second suspension medium.

In the process according to the invention, the first suspension of solid particles of an ethylene homopolymer prepared in the first reactor is fed to a first solid-liquid separator to obtain a stream rich in the diluent and a stream rich in the solid particles. At least part of the diluent stream is recycled back to the first polymerization reactor. The recycling back of the diluent stream to the first polymerization reactor is performed without purification to remove comonomer (or without any further purification of unit separation step). At least part of the particles stream is fed to a flash section to remove hydrogen, at least part of which hydrogen is recycled back to the first reactor. At least part of the hydrogen-depleted stream from the flash section is fed to the second polymerization reactor, which is also fed with ethylene and a comonomer and a second diluent. The multimodal ethylene copolymer is thus obtained by the process according to the invention as a second suspension of solid particles of the multimodal ethylene copolymer in a second suspension medium.

### DETAILED DESCRIPTION

The combination of the solid-liquid separator followed by the flash vessel decreases the energy consumption in the process.

Since no comonomer is used in the first polymerization reactor, the diluent extracted by the first solid-liquid separator does not need to be separated from any comonomer before being recycled back to the first reactor. The lack of need for separation decreases the energy required for recycling the diluent. The first diluent stream to be recycled to the first polymerization reactor further comprises hydrogen. The recycling of hydrogen back to the first polymerization reactor reduces the amount of fresh hydrogen that needs to be added to the first reactor. Further, since some amounts of diluent and hydrogen have already been separated out by the first solid-liquid separator, the amount of components to be flashed out by the flash section (hydrogen, diluent etc.) is decreased. This decreases the energy consumption for recycling hydrogen and diluent from the flash section which requires cooling and condensation. A large improvement in the overall energy efficiency of the process is thus achieved.

The first suspension is prepared in the first polymerization reactor at a pressure of P1. The first solid-liquid separator is operated at a pressure of P2. The first flash vessel is operated at a pressure of P3. Typically, P1>P2>P3, more typically P1>P2>P3.

Preferably, the difference between P1 and P2 is relatively small. Removing liquid from the first suspension at a relatively high pressure substantially decreases the energy required by the operation of the subsequent flash vessel. Preferably, P1-P2 is at most 0.5 bar, for example at most 0.3 bar or at most 0.1 bar. Preferably, the first solid-liquid separator is a centrifugal decanter or hydrocyclone.

Preferably, P3 is substantially lower than P2. The first flash vessel operated at a relatively low pressure removes the remaining diluent in addition to hydrogen. Preferably, most of the diluent is removed by the flash section, in which case the obtained hydrogen-depleted stream takes the form of a cake rather than a suspension. The near complete removal of the diluent taking place by the combination of the solid-liquid separator and the flash section allows the formation of two (nearly) independent diluent circuits, one for the first polymerization reactor and another for the second polymerization reactor. Having two independent diluent circuits allows recycling large portions of the diluents while preventing cross-contamination between the first and the second reactors while, specifically mixing of the comonomer with the first diluent is prevented.

Preferably, P2-P3 is at least 1.0 bar, at least 2.0 bar, at least 5.0 bar or at least 10 bar. P3 may for example be 1.0 to 5.0 barg, for example 1.2 to 3.5 barg. P3 may for example be 1.5×10⁵ to 3.5×10⁵ Pa.

### Multimodal Ethylene Copolymer

The ethylene copolymer obtained according to the invention is multimodal. In the context of the present invention the term “multimodal” shall indicate that the ethylene copolymer comprises at least two fractions of polymers which are obtained under different polymerization conditions. That means the term “multimodal” as used herein shall include also “bimodal”. The different polymerization conditions can for example be achieved by using different hydrogen concentrations in different polymerization reactors. The term “copolymer” includes both bipolymers (made of two monomers) and terpolymers (made of three monomers).

Preferably, the ethylene copolymer obtained by the process of the present invention is selected from ethylene copolymers of ethylene and a comonomer selected from C3-C12 α-olefin. Preferably, the comonomer is selected from 1-butene, 1-hexene, 4-methyl-1-pentene, 1-octene and 1-decene and mixtures thereof. More preferably, the comonomer is 1-hexene and/or 1-butene, most preferably 1-hexene.

Preferably, the amount of ethylene derived units is 60 to 99.8 wt % and the amount of the comonomer derived units in the copolymer of the invention is 0.2 to 40 wt %, for example 1 to 35 wt %, 3 to 30 wt %, 5 to 25 wt % or 10 to 20 wt %.

### Catalyst

The polymerization can be carried out using all customary olefin polymerization catalysts. That means the polymerization can be carried out using Phillips catalysts based on chromium oxide, using titanium-based Ziegler- or Ziegler-Natta-catalysts, or using single-site catalysts. For the purposes of the present invention, single-site catalysts are catalysts based on chemically uniform transition metal coordination compounds. Particularly suitable single-site catalysts are those comprising bulky sigma- or pi-bonded organic ligands, e.g. catalysts based on mono-Cp complexes, catalysts based on bis-Cp complexes, which are commonly designated as metallocene catalysts, or catalysts based on late transition metal complexes, in particular iron-bisimine complexes. Furthermore, it is also possible to use mixtures of two or more of these catalysts for the polymerization of olefins. Such mixed catalysts are often designated as hybrid catalysts. The preparation and use of these catalysts for olefin polymerization are generally known.

Preferred catalysts are of the Ziegler type preferably comprising a compound of titanium or vanadium, a compound of magnesium and optionally a particulate inorganic oxide as support.

Further examples of suitable catalysts are those described e.g. in WO2020135939, p. 5, lines 22-36, incorporated herein by reference.

### First Diluent and Second Diluent

Preferably, each of the first diluent and the second diluent is selected from n-alkanes, iso-alkanes and/or branched alkanes with carbon number 3 to 12 and combinations thereof. Suitable examples include propane, butane, isobutane, n-pentane, isopentane, neopentane, hexane, n-heptane, iso-heptane, octane. The first diluent and the second diluent may be of different types, but preferably are of the same type.

Preferably, each of the first diluent and the second diluent comprises neopentane and/or isobutane.

Most preferably, each of the first diluent and the second diluent comprises neopentane (also known as 2,2-dimethylpropane). Preferably, the amount of neopentane with respect to the total of the first diluent and the second diluent is at least 50 wt %, more preferably at least 60 wt %, more preferably at least 70 wt %, more preferably at least 80 wt %, more preferably at least 90 wt %, more preferably at least 95 wt %, more preferably at least 99 wt %.

The present inventors have found that the use of neopentane as the diluent advantageously results in the combination of less wax, low required pressure for polymerization, efficient recovery of the diluent and easy separation of the diluent from polyethylene particles.

Vapor pressures at different temperatures and boiling points at atmospheric pressure are shown below for some n-alkanes.

| | Vapor pressure (bar) | | | Boiling |
|---|---|---|---|---|
| | at 60 C. | at 70 C. | at 80 C. | point (° C.) |
| Propane | 21.2 | 25.9 | 31.4 | −42 |
| Butane | 6.4 | 8.1 | 10.2 | −1 |
| Hexane | 0.8 | 1.1 | 1.4 | 69 |
| Isobutane | 8.7 | 10.9 | 13.5 | −11.7 |
| Pentane | 2.1 | 2.8 | 3.7 | 36.1 |
| Neopentane | 4.6 | 5.8 | 7.3 | 9.5 |

It has been found that polyethylene chains have a lower solubility to propane and neopentane than to isobutane, pentane and butane. A lower solubility of polyethylene chains results in less amount of low molecular weight polyethylene (wax) becoming lost by being dissolved in the diluent.

Furthermore, it has been realized that the differences in the vapor pressures of n-alkanes results in differences in the pressure required during the polymerization. Neopentane has a much lower vapor pressure than propane and thus use of neopentane as the diluent requires a much lower pressure for the polymerization than the use of propane. Accordingly, the use of neopentane as the diluent is also advantageous in relation to the lower pressure required for the polymerization.

Furthermore, the condensation point of neopentane allows for efficient recovery of vaporized diluent by simple condensation with cooling water at low to moderate pressures, without the need to use high energy input unit operations such as compressors and/or chillers.

Furthermore, the boiling point of neopentane allows separation from polyethylene particles by simple flashing and stripping with nitrogen, without the need to use drying operations such as rotary dryers, or fluidized bed dryers, or steam dryers.

### Reactor Cascade

The process according to the invention is performed in a reactor cascade comprising a first polymerization reactor and a second polymerization reactor which are connected in series.

It is possible that the process of the present invention is only carried out in a series of two reactors (the first and the second polymerization reactor). It is however also possible that there are further reactors connected to upstream and/or downstream of these reactors. The presence of the further reactors has a positive influence on the homogeneity of the ethylene copolymer particles obtained.

There is no limit to the number of further reactors, for example 1, 2, 3 or 4, preferably 1 or 2. In some embodiments, the reactor cascade comprises one further polymerization reactor upstream of the first polymerization reactor (total number of reactors is 3). In some embodiments, the reactor cascade comprises one further polymerization reactor downstream of the second polymerization reactor (total number of reactors is 3). In some embodiments, the reactor cascade comprises one further polymerization reactor upstream of the first polymerization reactor and one further polymerization reactor downstream of the second polymerization reactor (total number of reactors is 4).

Preferably, these reactors are horizontal or vertical loop reactors or stirred tank reactors, particularly preferably Continuous Stirred Tank Reactors. The reactors can operate as fully liquid or in boiling point conditions. The reactors can be of different types, but are preferably of the same type. In some preferred embodiments, all reactors in the reactor cascade are horizontal loop reactors operating as fully liquid reactors. In other preferred embodiments, all reactors in the reactor cascade are Continuous Stirred Tank Reactor operating under boiling point conditions.

The reactor cascade may comprise a first group of reactors including the first polymerization reactor and further polymerization reactor(s) upstream of the first polymerization reactor and a second group of reactors including the second polymerization reactor and further polymerization reactor(s) downstream of the second polymerization reactor. The reactors in the first group produce an ethylene homopolymer and the reactors in the second group produce an ethylene copolymer. The reactors in the second group preferably operate at a lower temperature than those in the first group. The hydrogen contents in the reactors in the second group are typically less than those in the first group.

The further polymerization reactors (reactors in addition to the first and the second polymerization reactors) are suspension polymerization reactors, preferably the same type as the suspension reactors used in first and the second reactors.

Suspension polymerization processes comprising two or more suspension polymerization reactors connected in series have been known for many years. One of the reasons why cascades of two or more polymerization reactors are frequently used is that it is possible to set different reaction conditions in the polymerization reactors and thereby, for example, broaden the molecular weight distribution. Ethylene polymers with a broad molecular weight distribution are commonly used for a multitude of applications because they show advantages in product properties and processability. Such polymers are also often designated as bimodal or more generally as multimodal polyolefin polymers because they are polymerized in a cascade of two or more polymerization reactors under different reaction conditions. The term “multimodal”, as used herein and also frequently used in the art, shall include “bimodal”.

In such cases of polymerization in a cascade of polymerization reactors, a polymerization catalyst is fed together with monomers to a first reactor, the produced polymer, which still contains active polymerization catalyst, is transferred to a second polymerization reactor, which has different reactor conditions, and the polymerization is continued using the polymerization catalyst still contained in the polymer particle.

Normally the different reaction conditions in the different polymerization reactors are set by using different concentrations of hydrogen, which is commonly used as molecular weight regulator.

Preferably, the solids concentrations inside the reactors, defined as the weight of polymer in the total weight of the suspension, is between 15 and 60% wt., preferably between 25 and 55% wt., and most preferably between 35 and 50% wt.

The proportions of the polymers prepared in each of the polymerization reactors are not particularly limited. For example, when the number of the polymerization reactor in the reactor cascade is 4, 10 to 50 wt % or 20 to 40 wt % of the polymers may be produced in each of the polymerization reactor with respect to the total amount of polymers produced by the reactor cascade. The weight ratio of the ethylene homopolymer and the ethylene copolymer produced in the reactor cascade is not particularly limited.

### Step a)

In step a), ethylene, hydrogen and catalyst components and a first diluent are fed to the first polymerization reactor. Ethylene is polymerized. A first suspension of solid particles of an ethylene homopolymer in a first suspension medium is prepared.

Preferably, the polymerization in the first polymerization reactor is carried out at a pressure of 1 to 50 barg, for example 1 to 15 barg, 2 to 20 barg or 20 to 50 barg. The pressure may be selected e.g. based on the type of the first diluent.

Preferably, the polymerization in the first polymerization reactor is carried out at a temperature of 65 to 110° C., more preferably 65 to 90° C., and particularly preferably 75 to 85° C. The temperature in the first polymerization reactor is below the melting point of the polymer in the first reactor.

The first suspension medium which forms the liquid or supercritical phase of the first suspension consists of the first diluent and various components dissolved in the first suspension medium.

The first suspension medium comprises ethylene and residues of catalyst components, dissolved in the first suspension medium. The first suspension medium further comprises hydrogen dissolved in the first suspension medium. During the polymerization, low molecular weight hydrocarbon reaction products are also formed, which may include polyethylene waxes, oligomers, alkanes produced by polymerization (C4, C6, C8, C10, C12, C14 . . . ); alkene isomers (e.g. 2-hexene).

The first suspension medium is essentially free of the comonomer. Preferably, the amount of the comonomer in the first suspension medium is at most 0.1 wt % of the first suspension medium, more preferably the amount of comonomer in the first suspension medium is at most 0.01 wt % (or 100 ppm) of the first suspension medium.

The slurry average residence time in the first polymerization reactor may e.g. be 2 to 4 hours or 1 to 3 hours.

### Step b)

In step b), at least part of the first suspension from the first polymerization reactor is fed to a first solid-liquid separator to obtain a first diluent stream rich in the first diluent and a first particles stream rich in the solid particles of ethylene homopolymer.

A vessel may be present between the first polymerization reactor and the first solid-liquid separator. The vessel receives at least part (preferably all) of the first suspension from the first polymerization reactor and the first solid-liquid separator receives at least part (preferably all) of the first suspension from the vessel. The vessel allows for a smoother operation of the first solid-liquid separator. Preferably, the vessel is operated at substantially the same pressure as the first polymerization reactor and at same or lower temperature than the first polymerization reactor. The average residence time in the vessel may e.g. be between 2 and 20 minutes, preferably between 5 and 10 minutes. Some amount of vapor may be removed from the first suspension in the vessel, but preferably none. The temperature in the vessel may e.g. be between 35 and 95° C., preferably between 35 and 75° C. and most preferably between 35 and 55° C.

The first solid-liquid separator can be any suitable apparatus such as centrifugal decanters, hydrocyclones, filters or combinations thereof. Preferably the first solid-liquid separator is a centrifugal decanter. Preferably, the first solid-liquid separator is operated at substantially the same pressure as the first polymerization reactor (same or at most 0.5 bar lower than the pressure of the first polymerization reactor) and the optional vessel described above.

It is preferred that the first solid-liquid separator is operated such that the first particle stream does not comprise a large portion of the hydrogen in the first suspension. Preferably, the solid-liquid separator is operated such that the first particle stream comprises at most 30 wt %, more preferably at most 15 wt %, more preferably at most 8 wt %, of the hydrogen in the first suspension.

It is preferred that the first solid-liquid separator is operated such that the first diluent stream comprises a large portion of the first diluent in the first suspension. Preferably, the solid-liquid separator is operated such that the first diluent stream comprises at least 70 wt %, more preferably at least 85 wt %, more preferably at least 92 wt %, of the first diluent in the first suspension.

It is preferred that the solid-liquid separator is operated such that the first diluent stream is essentially free of dissolved polymer or wax.

At least part of the first diluent stream is recycled back to the first polymerization reactor. The transfer of said at least part of the first diluent stream may be direct or may be via an optional vessel present between the first solid-liquid separator and the first polymerization reactor. Average residence time in said vessel may e.g. be between 5 and 45 minutes, preferably between 5 and 30 minutes, most preferably between 5 and 20 minutes. Some amount of vapor may be removed from the vessel, but preferably the pressure and temperature in the vessel is such that no vapors leaves the vessel.

Part of the first diluent stream may be sent to the work-up section described in relation to optional step f). However, it is preferred that as much as possible of the first diluent stream is recycled back to the first polymerization reactor. This leads to low energy consumption.

Preferably, at least 75 wt %, more preferably at least 95 wt %, more preferably at least 99.5 wt % of the first diluent fed to the first polymerization reactor is fed as the recycled stream from the first solid-liquid separator.

### Step c)

In step c), the first particles stream rich in the solid particles is fed to a flash section, in which a vapor stream rich in hydrogen and a hydrogen-depleted stream (hydrogen-depleted suspension or hydrogen-depleted cake) are obtained. At least part of the vapor stream is recycled back to the first polymerization reactor.

Recycling of hydrogen is beneficial since hydrogen is required in the first polymerization reactor in which ethylene homopolymer is prepared and the presence of hydrogen is not required in the second polymerization reactor. The molecular weight of the ethylene copolymer prepared in the second polymerization reactor can be controlled by the amount of hydrogen fed to the second polymerization reactor. For obtaining a high molecular weight ethylene copolymer, a lower amount of hydrogen needs to be fed to the second polymerization reactor.

The flash section may comprise only one flash vessel (first flash vessel) or a plurality of flash vessels connected in series (first flash vessel and second flash vessel and any further flash vessel(s)). The second flash vessel operates at a lower pressure than the first flash vessel. The use of a plurality of flash vessels increases the flashing efficiency and lowers the energy when recovering flashed components.

Preferably, the flash section is operated such that the hydrogen-depleted stream fed from the flash section to the second polymerization reactor contains substantially no hydrogen. Preferably, the flash section is operated such that at least 99 wt %, more preferably at least 99.5 wt %, more preferably at least 99.9 wt %, more preferably at least 99.95 wt %, more preferably at least 99.99 wt %, of the hydrogen in the first particles stream is removed to obtain the hydrogen-depleted stream. Higher level of depletion of the hydrogen in the hydrogen-depleted stream allows a higher molecular weight ethylene copolymer to be obtained in the second polymerization reactor.

The flashing in the flash section results in a substantial portion of the first diluent ending up in the vapor stream. Thus the vapor stream rich in hydrogen obtained by the flash section comprises hydrogen and the first diluent. Preferably, the flash section is operated such that the hydrogen-depleted stream contains substantially no first diluent. Preferably, the flash section is operated such that no more than 10%, preferably no more than 5%, and most preferably no more than 1% of the first diluent in the first particles stream is present in the hydrogen-depleted stream. Preferably, the flash section is operated such that no more than 10 wt %, preferably no more than 5 wt %, and most preferably no more than 1 wt % of the first diluent in the first particles stream is present in the hydrogen-depleted stream.

When at least part of the vapor stream is recycled back to the first polymerization reactor, at least part of the hydrogen in the vapor stream and at least part of the first diluent in the vapor stream are recycled back to the first polymerization reactor. Preferably, at least 50 wt %, more preferably at least 60 wt %, more preferably at least 70 wt %, more preferably at least 80 wt %, more preferably at least 90 wt %, more preferably at least 95 wt %, more preferably at least 99 wt %, of the first diluent in the first particles stream is recycled back to the first polymerization reactor.

Preferably, at least 50 wt %, more preferably at least 60 wt %, more preferably at least 70 wt %, more preferably at least 80 wt %, more preferably at least 90 wt %, more preferably at least 95 wt %, more preferably at least 99 wt %, of the first diluent fed to the first polymerization reactor in step a) is fed as the recycled stream from the first solid-liquid separator (the at least part of the first diluent stream being recycled back to the first polymerization reactor of step b)) and the recycled stream from the flash section (the at least part of the vapor stream being recycled back to the first polymerization reactor (step c)).

The vapor stream may be fed to a heat exchanger to obtain a liquid stream of the first diluent, which may be recycled back to the first polymerization reactor. The heat exchanger may use cooling water or a chiller condenser.

In some embodiments, the flash section comprises the first flash vessel and the second flash vessel, the vapor stream from the first flash vessel is fed to a heat exchanger which uses cooling water, the vapor stream from the second flash vessel and the non-condensed stream leaving the cooling water heat exchanger are fed to a heat exchanger which uses a chiller condenser.

A heater may be present between the first solid-liquid separator and the first flash vessel. The heater is configured for receiving the first particles stream from the first solid-liquid separator and heating it before transferring it to the flash first vessel when necessary.

Preferably, the first flash vessel is an adiabatic flash. In this case, the heater is not necessary or its heat duty is equal to zero.

In another embodiment of the invention, the first flash vessel is not adiabatic and the heater is used for heating up the first particles stream to a temperature below the melting temperature of the polymer.

### Step d)

In step d), the hydrogen-depleted stream is fed to the second polymerization reactor as well as ethylene and the comonomer. Further, a second diluent is fed to the second polymerization reactor. The monomers are polymerized. A second suspension of solid particles of the multimodal ethylene polymer in a second suspension medium is prepared.

Preferably, the polymerization in the second polymerization reactor is carried out at a pressure of 1 to 50 barg, for example 1 to 15 barg, 2 to 20 barg or 20 to 50 barg. The pressure may be selected e.g. based on the type of the second diluent.

Preferably, the polymerization in the second polymerization reactor is carried out at a temperature of 65 to 110° C., more preferably 65 to 90° C., and particularly preferably 75 to 85° C. The temperature in the second polymerization reactor is below the melting point of the polymer in the second reactor.

The second suspension medium which forms the liquid or supercritical phase of the second suspension is formed by the medium of the hydrogen-depleted stream from the flash vessel and the second diluent, as well as various components dissolved in the second suspension medium.

The second suspension medium comprises ethylene, comonomer and residues of catalyst components, dissolved in the second suspension medium. The second suspension medium may comprise hydrogen, but its level is low. Similar to the polymerization in the first reactor, low molecular weight hydrocarbon reaction products are also formed during the polymerization, which may include polyethylene waxes, oligomers, alkanes produced by polymerization (C4, C6, C8, C10, C12, C14 . . . ); alkene isomers (e.g. 2-hexene).

Preferably, the amount of the comonomer in the second suspension medium is 0.1 to 10 wt %, more preferably 1.0 to 8.0 wt %, more preferably 2.0 to 6.0 wt %, of the second suspension medium.

Preferably, no fresh hydrogen is fed to the second polymerization reactor. The amount of hydrogen in the second polymerization reactor is controlled by the pressure setting in the flashing section.

The slurry average residence time in the second reactor may e.g. be 0.5 to 3 hours or 1 to 2 hours.

### Step e)

The process according to the invention may further comprise (after step d)):
e) feeding at least part of the second suspension to a second solid-liquid separator to obtain a second diluent stream rich in the second diluent and a second particles stream rich in the solid particles, wherein at least part of the second diluent stream is recycled back to the second polymerization reactor.

A vessel may be present between the second polymerization reactor and the second solid-liquid separator. The vessel receives at least part (preferably all) of the second suspension from the second polymerization reactor and the second solid-liquid separator receives at least part (preferably all) of the second suspension from the vessel. The vessel allows for a smoother operation of the second solid-liquid separator. Preferably, the vessel is operated at substantially the same pressure as the second polymerization reactor and at same or lower temperature than the second polymerization reactor. The average residence time in the vessel may e.g. be between 2 and 20 minutes, preferably between 5 and 10 minutes. Some amount of vapor may be removed from the second suspension in the vessel, but preferably none. The temperature in the vessel may e.g. be between 35 and 95 C, preferably between 35 and 75 C and most preferably between 35 and 55 C.

The second solid-liquid separator can be any suitable apparatus such as centrifugal decanters, hydrocyclones, filters or combinations thereof. Preferably the first solid-liquid separator is a centrifugal decanter. Preferably, the second solid-liquid separator is operated at substantially the same pressure as the second polymerization reactor (same or at most 0.5 bar lower than the pressure of the first polymerization reactor) and the optional vessel described above.

It is preferred that the second solid-liquid separator is operated such that the second diluent stream comprises a large portion of the second diluent in the second suspension. Preferably, the second solid-liquid separator is operated such that the second diluent stream comprises at least 70 wt %, more preferably at least 85 wt %, more preferably at least 92 wt %, of the second diluent in the second suspension.

It is preferred that the second solid-liquid separator is operated such that the second diluent stream is essentially free of dissolved polymer or wax.

At least part of the second diluent stream is recycled back to the second polymerization reactor. The transfer of said at least part of the second diluent stream may be direct or may be via an optional vessel present between the second solid-liquid separator and the second polymerization reactor. Average residence time in said vessel may e.g. be between 5 and 45 minutes, preferably between 5 and 30 minutes, most preferably between 5 and 20 minutes. Some amount of vapor may be removed from the vessel, but preferably the pressure and temperature in the vessel is such that no vapors leaves the vessel.

Part of the second diluent stream may be sent to the work-up section described in relation to optional step f). However, it is preferred that as much as possible of the second diluent stream is recycled back to the second polymerization reactor. This leads to low energy consumption.

Preferably, at least 75 wt %, at least 95 wt %, at least 99.5 wt % of the second diluent fed to the second polymerization reactor is fed as the recycled stream from the second solid-liquid separator.

The recycling of the first diluent and the recycling of the second diluent are performed independently in order to prevent the comonomer fed to the second polymerization reactor to be mixed with the first diluent to be recycled to the first polymerization reactor. Thus, the second diluent stream is not mixed with the stream to be recycled back to the first polymerization reactor. The second diluent stream is not fed to the flash section.

### Step f)

The process according to the invention may further comprise (after step e)):
f) feeding at least part of the second diluent stream to a diluent work-up section to obtain a third diluent stream rich in the second diluent and a comonomer stream rich in the comonomer, wherein at least part of the third diluent stream is recycled back to the first polymerization reactor and/or the second polymerization reactor.

Preferably, at most 20 wt %, preferably at most 10 wt %, more preferably at most 6.5 wt % of the total amount of first diluent and the second diluent fed to the first polymerization reactor and the second polymerization is fed to the work-up section.

Preferably, at most 0.5 ton, preferably at most 0.25 ton, more preferably at most 0.12 ton of diluent is fed to the work-up section per ton of the ethylene copolymer produced.

Preferably, the diluent work-up section comprises a distillation column or a series of distillation columns that separates a heavy component rich stream through the bottom, a comonomer rich side stream, an essentially pure third diluent stream and a lights purge.

Preferably, the content of comonomer in the diluent rich stream is less than 10000 ppm wt. preferably less than 1000 ppm wt. and more preferably less than 250 ppm wt.

The heavy component rich stream may be purged out of the process. The comonomer rich stream is preferably recycled back to the second polymerization reactor. The third diluent stream is preferably recycled back to the first polymerization reactor and/or the second polymerization reactor. The lights stream on tops of the distillation column is purged out of the process or fed to a nitrogen-hydrocarbons separation unit.

The diluent work-up section may also be fed with part of the first diluent stream.

The diluent work-up section may further comprise a wax separation unit upstream of the distillation column. Such unit can be made of unit operations such as evaporators, filters, distillation towers, drying-belts, decanters or any combination thereof. A preferred unit operation is an evaporator, preferably a double effect evaporator and most preferably a triple effect evaporator. As outcome of this wax separation unit a purified wax stream and a wax-depleted stream rich in diluent with presence of comonomer and dissolved monomers are produced. Purified wax stream is sent out of the process and can be sold for commercial purposes, burned for energy production or any other suitable industrial use.

In some preferred embodiments, the diluent work-up section does not comprise a wax separation unit, i.e. the process according to the invention does not comprise the step of removing wax from the first diluent stream or the second diluent stream. This increases energy efficiency and may be achieved especially with the use of neopentane as the first and the second diluents. This is particularly suitable when neopentane is used as the diluents.

### Step g)

The process according to the invention may further comprise (after step e)):
g) purifying the second particles stream by flashing and purging to obtain the solid particles of the multimodal ethylene copolymer.

The solid particles of the multimodal ethylene copolymer so-obtained may be subjected to typical operations such as pelletization in a known manner.

In step g), the second particles stream is subjected to purification to obtain pure polymer particles. The purification may involve the use of a flash vessel and a purge vessel.

The purification by the use of a flash vessel may be performed in a similar manner as described with respect to step c). Preferably, the flashing of the second particles stream is performed such that all of the second diluent is removed. This eliminates the necessity for purification by the use of a dryer involving heating. This increases process efficiency. Accordingly, in some preferred embodiments, step g) does not involve the use of a dryer involving heating.

In the purge vessel, remaining diluent, non-reacted monomers and inert gases are purged out. This may be done by the use of a stripping agent, e.g. nitrogen in countercurrent of the polymer flow through the purge vessel.

The components removed from the second particles stream by purification may be recycled in the process in the manner known to the skilled person.

### Specific Embodiments

In some embodiments, at least 50 wt % of the first diluent and the second diluent is neopentane, each of the first polymerization reactor and the second polymerization reactor is a continuous stirred tank reactor working at boiling point conditions and a pressure of between 2 and 20 barg, preferably between 3 and 14 barg.

In some embodiments, at least 50 wt % of the first diluent and the second diluent is isobutane, each of the first polymerization reactor and the second polymerization reactor is a horizontal slurry loop working in supersaturated conditions and a pressure of between 20 and 50 barg, preferably between 35 and 45 barg.

In some embodiments, at least 50 wt % of the first diluent and the second diluent is hexane isomers, each of the first polymerization reactor and the second polymerization reactor a is continuous stirred tank reactor working at boiling conditions and a pressure of between 1 and 15 barg, preferably between 2 and 13 barg.

In some embodiments, at least 50 wt % of the first diluent and the second diluent is heptane isomers, each of the first polymerization reactor and the second polymerization reactor a is continuous stirred tank reactor working at boiling conditions and a pressure of between 1 and 15 barg, preferably between 2 and 13 barg.

In some embodiments, antistatic agents are added in some or all of the polymerization reactors in the reactor cascade in order to avoid reactor fouling. In other embodiments, no antistatic agents are added in the polymerization reactors in the reactor cascade.

Preferably, none of the first diluent stream, the second diluent stream and the third diluent stream are subjected to a catalytic hydrogenation before being recycled back to the first polymerization reactor or the second polymerization reactor.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated referring to drawings in which:

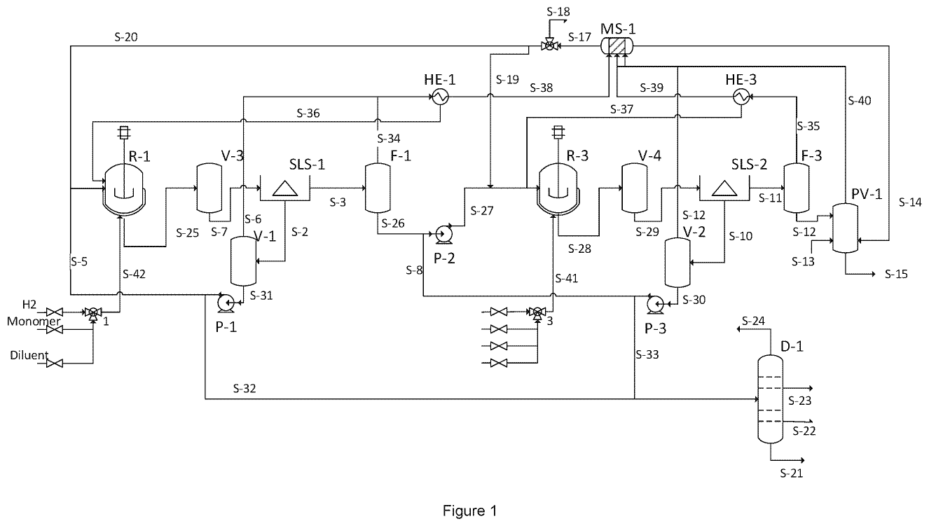

FIG. 1 schematically illustrates an embodiment of a system for performing the process of the invention; and

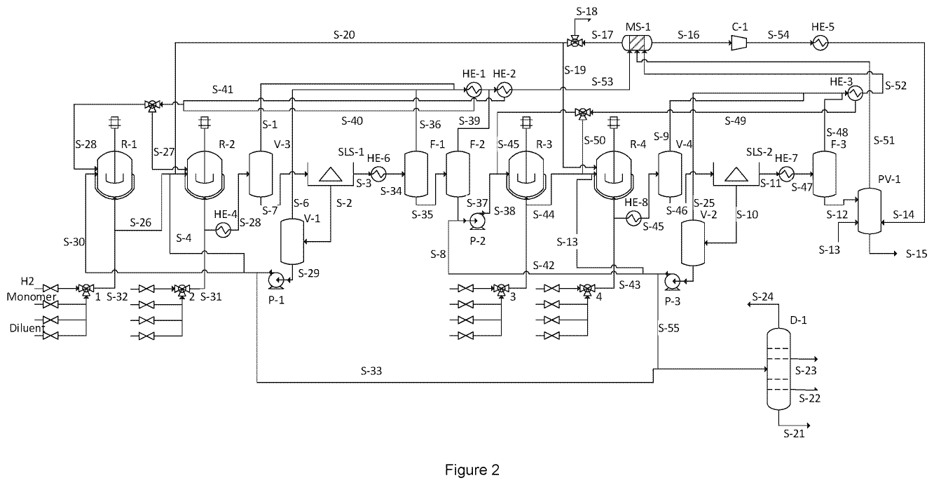

FIG. 2 schematically illustrates a further embodiment of a system for performing the process of the invention.

FIG. 1 shows an example of a schematic of the process according to the invention. The system in this example has a reactor cascade of two polymerization reactors and the flash section between the two polymerization reactors has one flash vessel.

Ethylene, hydrogen, and catalyst components are fed to a first polymerization reactor R-1, along with a first diluent. Ethylene polymerization takes place and a first suspension S-25 of solid particles of a first ethylene polymer in a first suspension medium is prepared.

The first suspension S-25 is withdrawn from the first polymerization reactor R-1 and fed to a receiver vessel V-3 and fed to a first solid-liquid separator SLS-1 as S-7. The first solid-liquid separator SLS-1 separates the first suspension S-7 into a first diluent stream S-2 and a particles rich stream S-3.

The first diluent stream S-2 is transferred to a receiver vessel V-1. Vapor S-6 is removed from the first diluent stream S-2 in the receiver vessel V-1 and the remaining diluent stream S-5 is then recycled back to the first polymerization reactor R-1.

The first particles stream S-3 is transferred to a flash vessel F-1 which flashes out hydrogen, the first diluent and inerts (vapor stream S-34) to obtain a hydrogen depleted stream S-26. The vapor stream S-34 from the flash vessel F-1 is fed to a heat exchanger HE-1 to obtain a liquid stream of the first diluent S-20, which is recycled back to the first polymerization reactor R-1. The remaining non-condensed components S-38 from the heat exchanger HE-1 is fed to a nitrogen-hydrocarbons separation unit MS-1.

The hydrogen depleted stream S-26 from the flash vessel F-1 is transferred to a second polymerization reactor R-3 for further polymerization. The polymer particles in the hydrogen depleted stream S-26 are re-slurried by the diluent S-8 recycled from the work-up section D-1 described later to obtain stream S-27. Ethylene and comonomer are fed to the second polymerization reactor R-3, along with a second diluent. Copolymerization of ethylene and the comonomer takes place and a second suspension S-28 of solid particles of ethylene copolymer in a second suspension medium is prepared.

The second suspension S-28 is withdrawn from the second polymerization reactor R-3 and fed to a receiver vessel V-4 and fed to a second solid-liquid separator SLS-2 as S-29. The second solid liquid separator SLS-2 separates the second suspension S-29 into a second diluent stream S-10 and a particles rich stream S-11.

The second diluent stream S-10 is transferred to a receiver vessel V-2. Vapor S-12 is removed from the second diluent stream S-10 in the receiver vessel V-2 to obtain stream S-30.

Part S-8 of the stream S-30 is then recycled back to the second polymerization reactor R-3. Part S-33 of the stream S-30 is fed to a diluent work-up section D-1.

The diluent work-up section D-1 separates the diluent stream fed to it into a heavy component rich stream S-21, a comonomer rich side stream S-22, a third diluent stream S-23 which is essentially purely diluent and a lights purge S-24.

The second particles stream S-11 is transferred to a flash vessel F-3 which flashes out hydrogen, ethylene, the second diluent and inerts (vapor stream S-35). The suspension S-12 from the flash vessel F-3 is transferred to a purge vessel PV-1 in which the remaining amount of diluent, non-reacted monomers and organic inert gases present in the suspension is removed. Stripping agent S-14 (e.g. nitrogen) in countercurrent of the polymer flow is used. Stream S-13 provides enough make-up stripping agent to compensate the losses incurred in the process. Free flowing particles of the ethylene copolymer S-15 are obtained without the use of a dryer involving heating. Free flowing particles of the ethylene copolymer S-15 can be transferred e.g. to a pelletizer (not shown) directly from the purge vessel PV-1.

The vapors leaving the purge vessel PV-1 along with the vapors leaving the heat exchangers HE-1 and HE-3 are fed to a nitrogen-hydrocarbons separation unit MS-1. Nitrogen-hydrocarbons separation unit MS-1 may be composed of the required unit operations for the separation of the feed into a nitrogen rich stream and nitrogen depleted stream S-17. In a preferred embodiment of the invention, the nitrogen-hydrocarbons separation unit MS-1 is a membrane separation package.

FIG. 2 shows an example of a schematic of the process according to the invention. Elements in the system of FIG. 2 similar to FIG. 1 are indicated by same reference signs as in FIG. 1. Only the different elements from the example of FIG. 1 are described below.

In this system, the reactor cascade comprises two ethylene homopolymerization reactors R-1 and R-2 and two ethylene copolymerization reactors R-3 and R-4. Heat exchangers HE-2, HE-5, HE-4, HE-6, HE-8 and HE-7 are present. The flash section between the polymerization reactor R-2 and the polymerization reactor R-3 has two flash vessels F-1 and F-2. A vapor flow S-1 is fed to the heat exchanger HE-1.

1. A process for the preparation of a multimodal ethylene copolymer in a reactor cascade comprising a first polymerization reactor (R-1) and a second polymerization reactor (R-3), the process comprising:
a) feeding ethylene, hydrogen and catalyst components and a first diluent to the first polymerization reactor (R-1) to prepare a first suspension of solid particles of an ethylene homopolymer in a first suspension medium,
b) feeding at least part of the first suspension to a first solid-liquid separator (SLS-1) to obtain a first diluent stream (S-2) rich in the first diluent and a first particles stream (S-3) rich in the solid particles, wherein at least part (S-5) of the first diluent stream (S-2) is recycled back to the first polymerization reactor (R-1),
c) feeding the first particles stream (S-3) to a flash section comprising a first flash vessel (F-1) and an optional second flash vessel (F-2) to obtain a vapor stream rich in hydrogen and a hydrogen-depleted stream, wherein at least part of the vapor stream is recycled back to the first polymerization reactor (R-1) and
d) feeding the hydrogen-depleted stream, ethylene and a comonomer and a second diluent to the second polymerization reactor (R-3) to prepare a second suspension of solid particles of the multimodal ethylene copolymer in a second suspension medium.

2. The process according to claim 1, wherein the first suspension is prepared in the first polymerization reactor at a pressure of P1, the first solid-liquid separator is operated at a pressure of P2, the first flash vessel is operated at a pressure of P3, wherein P1-P2 is at most 0.5 bar and P2>P3.

3. The process according to claim 1, wherein the first solid-liquid separator is a centrifugal decanter or hydrocyclone.

4. The process according to claim 1, further comprising
e) feeding at least part of the second suspension to a second solid-liquid separator (SLS-2) to obtain a second diluent stream (S-10) rich in the second diluent and a second particles stream (S-11) rich in the solid particles, wherein at least part (S-8) of the second diluent stream (S-10) is recycled back to the second polymerization reactor (R-3).

5. The process according to claim 4, further comprising
f) feeding at least part of the second diluent stream (S-10) to a diluent work-up section (D-1) to obtain a third diluent stream (S-23) rich in the second diluent and a comonomer stream (S-22) rich in the comonomer, wherein at least part of the third diluent stream (S-23) is recycled back to the first polymerization reactor (R-1) and/or the second polymerization reactor (R-3).

6. The process according to claim 5, wherein at most 20 wt % of the total amount of first diluent and the second diluent fed to the first polymerization reactor and the second polymerization is fed to the work-up section (D-1).

7. The process according to claim 4, further comprising
g) purifying the second particles stream (S-11) by flashing and purging to obtain the solid particles of the multimodal ethylene copolymer (S-15).

8. The process according to claim 1, wherein the ethylene copolymer is selected from ethylene copolymers of ethylene and C3-C12 α-olefin and/or wherein each of the first diluent and the second diluent is selected from n-alkanes, iso-alkanes and/or branched alkanes with carbon number 3 to 12 and combinations thereof.

9. The process according to claim 1, wherein each of the first diluent and the second diluent comprises neopentane.

10. The process according to claim 1, wherein the reactor cascade comprises one further polymerization reactor upstream of the first polymerization reactor and/or one further polymerization reactor downstream of the second polymerization reactor.

11. The process according to claim 1, wherein the first solid-liquid separator is operated such that the first particle stream comprises at most 30 wt % of the hydrogen in the first suspension.

12. The process according to claim 1, wherein the first solid-liquid separator is operated such that the first diluent stream comprises at least 70 wt % of the first diluent in the first suspension.

13. The process according to claim 1, wherein the flash section comprises the first flash vessel (F-1) and the second flash vessel (F-2), the vapor stream from the first flash vessel (F-1) is fed to a heat exchanger (HE-1) which uses cooling water, the vapor stream from the second flash vessel (F-2) is fed to a heat exchanger (HE-2) which uses a chiller condenser.

14. The process according to claim 1, wherein the flash section is operated such that at least 99 wt % of the hydrogen in the first particles stream is removed to obtain the hydrogen-depleted stream and/or
wherein the flash section is operated such that no more than 10% of the first diluent in the first particles stream is present in the hydrogen-depleted stream.

15. The process according to any claim 1, wherein at least 50 wt % of the first diluent in the first particles stream is recycled back to the first polymerization reactor.
